(19) United States
(12) Patent Application Publication
(10) Pub. No.: US 2019/0318222 A1
(43) Pub. Date: Oct. 17, 2019

(54) Intelligent Cloud Based Product Development Guidance

(71) Applicant: Venkat Mallela, San Marco's, CA (US)

(72) Inventor: Venkat Mallela, San Marco's, CA (US)

(21) Appl. No.: 15/954,611

(22) Filed: Apr. 17, 2018

(51) Int. Cl. G06N 3/00; G06F 17/30; G06Q 10/06; G06F 17/28

(52) U.S. Cl. CPC G06N 3/006; G06F 17/30864; H04L 67/10; G06F 17/28; G06Q 10/0635

(57) ABSTRACT

This disclosure relates generally to cloud based software application enable for data processing comprising of a database, information flow charts and a suite of artificial intelligence tools to develop a complete plan for a new product or idea. A cloud platform for managing new product development by simply taking input from the generated idea is provided herein. The platform includes a server connected to computing resources, arranged to provide user a platform to develop new product development prototypes, process flows and a complete plan.

### BACKGROUND

### Field of the Invention

The invention relates to cloud based software application which guides a user to develop a product from an idea using a flexible information flow framework through a suite of artificial intelligence tools. The AI tools can use user input, which can be text, images or other media to query a wide variety of data from the internet, custom databases or social media to guide the user with the right context. With that information the customer knows where to complete the business transaction.

The present invention relates to the field of cloud computing, and more particularly, to a platform for managing ideas and information flow as a service applications in a cloud computing environment. The application would provide guidance through a step by step development process that uses questions and AI to create a unique roadmap for the user to follow in designing, developing and delivering their products and ideas to market. The invention is based to help the user for product development from an idea through use of artificial intelligence.

### Description of the Related Art

Cloud computing is an emerging technology in the information technology (IT) industry. Cloud computing allows for the moving of applications, services and data from desktop computers back to a main server farm. The server farm may be off premises and be implemented as a service. By relocating the execution of applications, deployment of services, and storage of data, cloud computing offers a systematic way to manage costs of open systems, centralize information, and enhance robustness and reduce energy costs.

Use of service-oriented architecture (SOA) environments and information services is fast becoming the preferred implementation for enterprise systems. Using SOA, an enterprise may be visualized as a collection of loosely coupled building blocks, called information services or business services. Information services provide a discrete business function, such as, for example, checking credit, opening an account, and so on, that can be adapted to a particular business context. As a business expands its enterprise capabilities, more information services are added to the network to accommodate the expansion. However, the design and development of information services is an errorprone, manual process, which relies heavily upon the skill and experience of a designer known as a solution architect. Because this software design process depends upon a human element, the information services within an enterprise system may lack consistency.

In addition, many enterprises are very good at producing, developing, and harvesting information technology (IT) assets, but are very poor and unsuccessful at consuming or reusing these IT assets. Two of the potentially most useful types of IT assets in software development are software models and software patterns. Primarily due to the inherent complexity involved in understanding the specific requirements and fit for a given software architecture, this long and difficult process of engineering software architectures has seen little application of reusable IT assets and instead has been uniquely developed for each new business scenario.

In light of previous developments, no suite or application was facilitating only an idea to be developed as a complete solution. Most of the focus was on software development and giving information flow. The current invention is based on developing a complete plan and architecture for new products, service oriented ideas simply generated through an idea. The invention is based to develop the flow through different information flow charts and questions for which the user would give the input. At the end a complete solution would be developed, which would be based on the users input. In the same context, too date most of the new product development ideas and plans were paper oriented and required many changes before coming to the blueprint version. Prior embodiments in the field were not providing development of a whole product just through the input of idea and data. The previous embodiments in the field did not provide such facilitation and hence the idea and application holds its own novelty in the field of product development, AI & cloud-based applications.

### SUMMARY

The invention is a software application & website accessible through mobile and computing devices that allows potential users to develop a product through their ideas and input. The invention is a cloud based AI system for automatically creating a desired “Product Development” plan or application design. In response to an input the system creates a desired new product which can be a software application, product or provision of service through information based flow charts, AI tools and a system of AI algorithms.

The system compromises of a frameworks of product development and design thinking embedded with a system of AI tools to guide the user at every step. A step-bystep process is provided through this application to give an end result in form a complete prototype or blue print for a new product or services.

According to one embodiment of the present invention, a desired new product prototype, flow chart or design is automatically created. In response to an input to create the desired new product prototype, functional requirements for the desired idea are collected through input from the user. Then, non-functional requirements associated with every input of functional requirement are retrieved. In addition, software and business models, patterns, and flow charts associated with the input functional requirements are retrieved. Based on the input and retrieved models are transformed into flow charts and designs for the new product. Finally, the architecture for the desired business, services, software or product is given as an output in form of a complete plan and design for the initial idea given in form of input by the user.

The current cloud based application is basically an Al guidance system which provides the users with an individualized path to success. The application is not a rote process but an individualized plan based on users needs, input and goals. The application on the top provides the process, decisions and tools that user requires in order to be successful every step of the way.

The application is based on bringing users ideas and imagination into reality through design and development thinking enabled through AI suite and tools. The application develops the ideas keeping Planning and Execution of the product development ideology. The application is designed to be extremely flexible and customizable.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

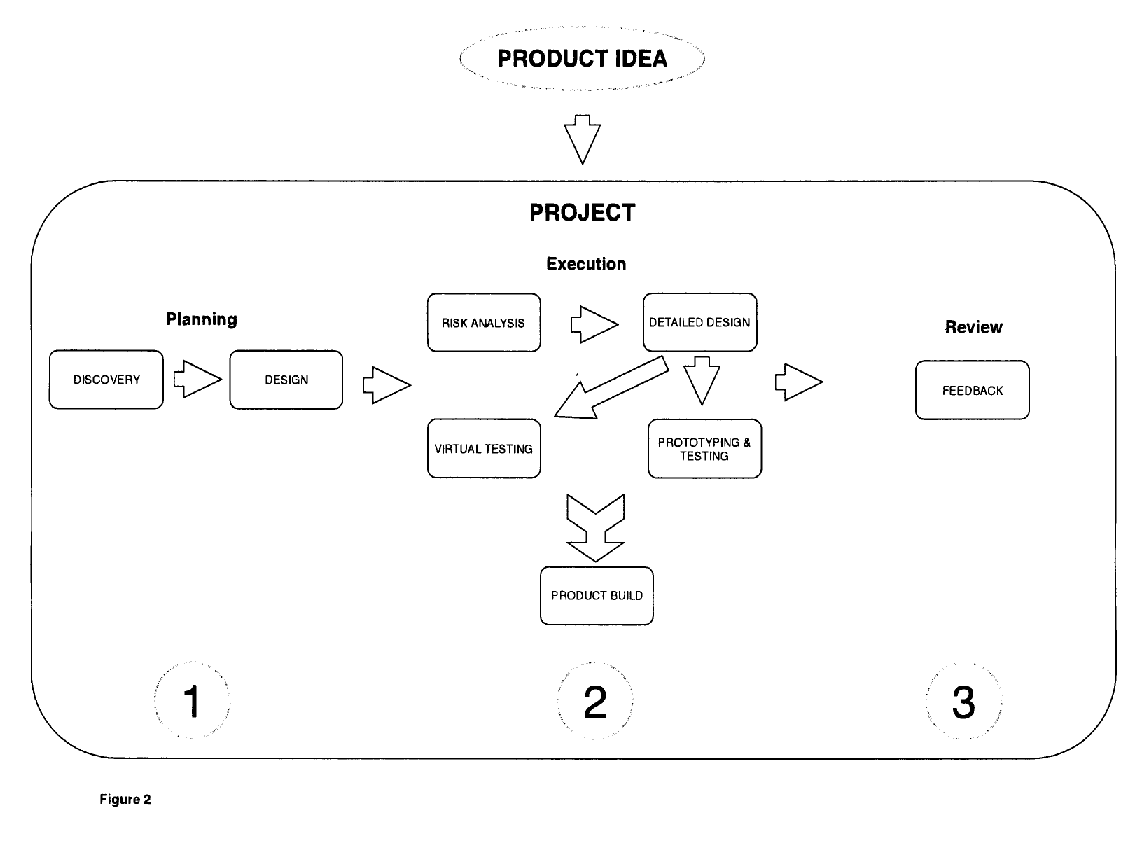

Developed application has three phases in the product development platform. The whole input and development is done in three phases Planning, Execution and Review. FIG. 2 gives the block diagram of the complete process with all three phases. The planning phase caters the input from the user in different aspects working more on the discovery pattern followed by giving the idea a design. The execution phase deals with the risk analysis, detailed design process, prototyping, testing facilitated by virtual testing ending at building the product. The third phase is based on the review given by the user for further betterment of the idea and product prototype.

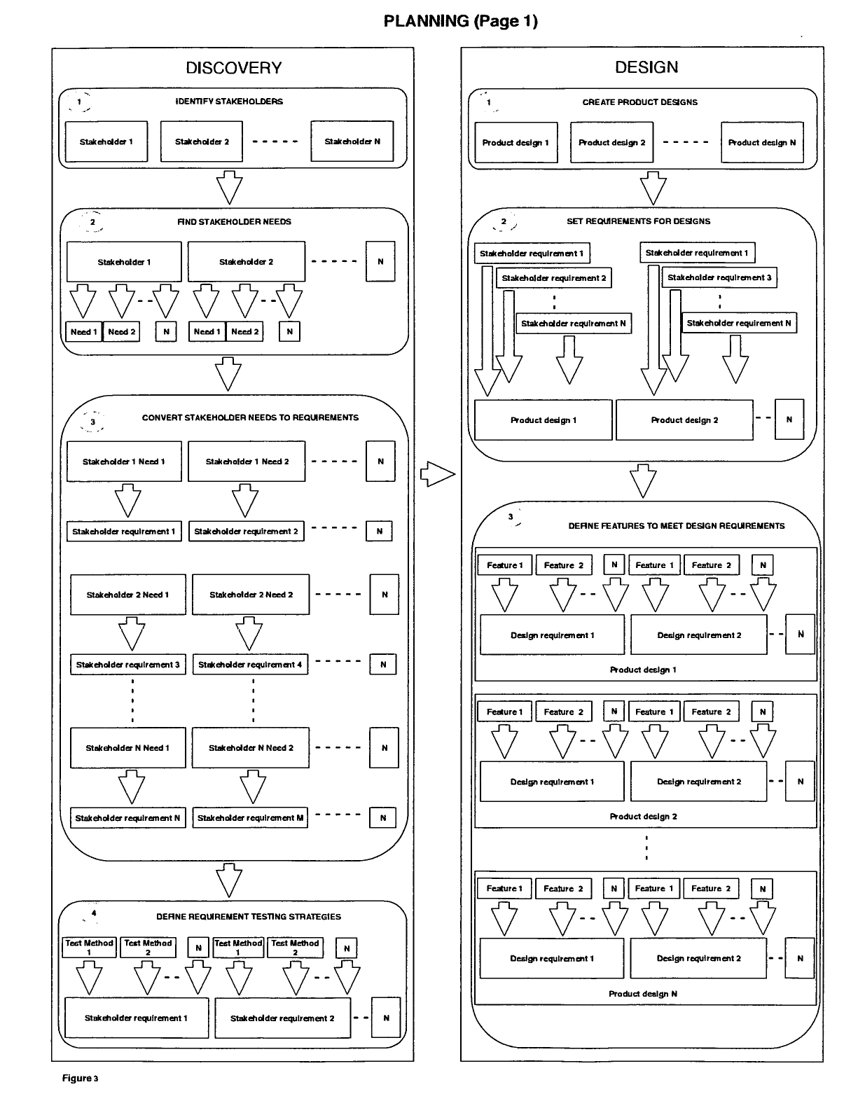

In the planning phase the application would ask the user multiple inputs and queries related to their idea and product. The application is designed on real time business plan formats to acquire maximum number of input in order to model and design the prototype to the most optimum level. The first level of input is based on identification product or service stakeholders. This step prompts the user to think out of the box and foresee the ultimate goal and usage of the product and service. In this manner, the user inputs the maximum utility of the product or service coming ahead of the stage of ideology. FIG. 3 indicates the flow and all inputs required from the user.

The same stage further intervenes and asks the user to input the identify the needs of stakeholder for the product or service. The system would ask multiple uses and needs for each stakeholder in order to further mapping and gather common and out of the way, requirements and needs in order to make a comprehensive flow and business plan. FIG. 3 indicates the flow, where multiple inputs are taken from the user in order to define the features to meet design requirements.

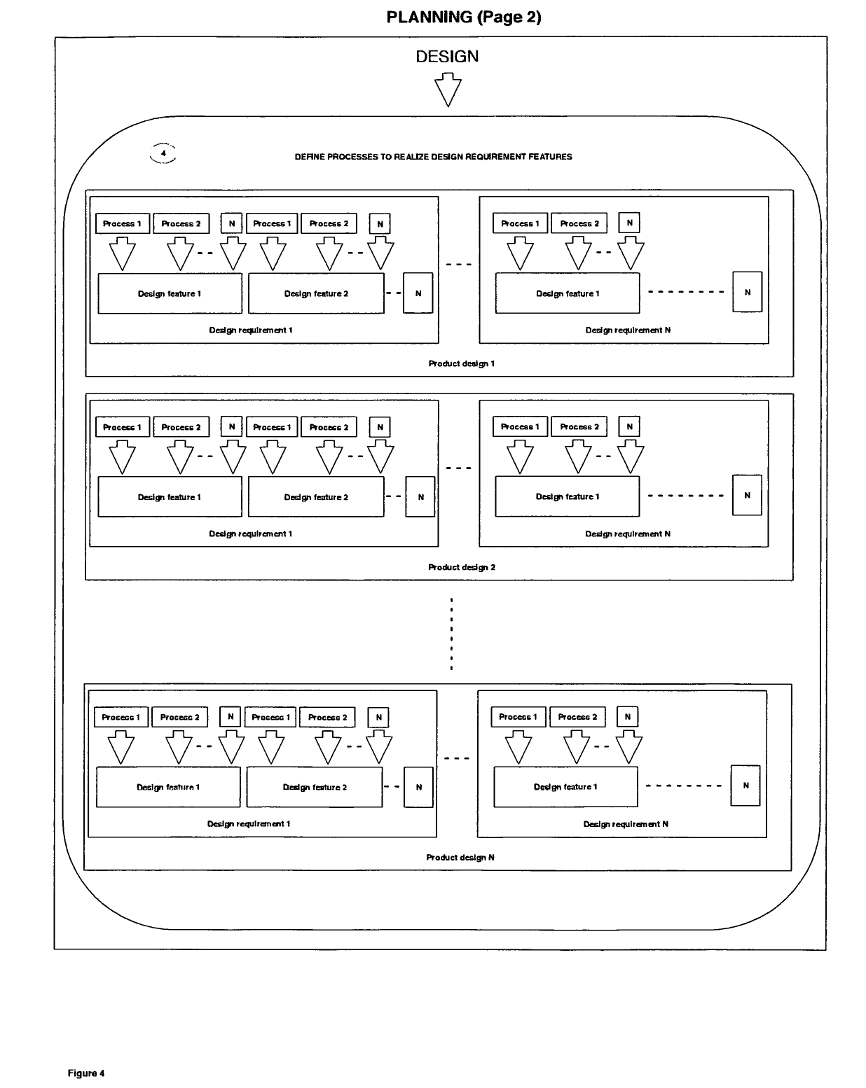

The system further converts the needs into requirements based on the input by the user, hence defining and modeling the requirements of the stakeholders for future business models and strategies. FIGS. 4 gives the complete flow processes for realization of design requirement features and complete the planning phase.

The system is embedded with different testing methods. The testing methods in the first stage would test different requirements of the stakeholders before going for design stage of the product. These tests will be applied on real time scenarios and algorithms.

The second stage of the systems asks the user to input different product specifications and requirements. It also inquires about different specs and features of the product to cater different needs of the stakeholders. The user is prompted to input the design features in light of stakeholder requirements.

In light of the requirements different product designs are generated. The product designs can go till Nth value as indicated in FIGS. 3 and 4, without limiting the user to give input.

In the 3^{rd} stage the system identifies test methods by combining the input data so far acquired by the user. The tests are again run on real time scenarios based on stakeholder needs, requirements and different product designs.

In the next stage the system matches the requirements and design features to make the first product model. By combining and matching the features and requirements the system comes up with actual design requirements for the product or service the user had in mind as an idea or raw format.

In light of the design features the system generates number of business processes. This step is kept to define real time processes to realize the design requirement features. For multiple design features multiple number of processes are defined and modeled by the system. The possibilities of designing the processes can go unlimited or up to the defined number of design feature model sets.

The next stage based on matching the features, designs and processes for the product or services in real time. This step is the final step before defining the product or service concept in real time.

The final step in the planning phase is generating multiple product prototypes and concepts applicable in business and real time world. At this stage, the user has a good idea of transformation of their raw idea or thought process.

On completion of planning phase the next execution stage of the product development starts its processing. Different number of designed product concepts are forwarded to the next stage to apply multiple risk factors. The risk factors are based on actual macro-environmental factors that can have multiple effects including failure of the product, idea or thought process.

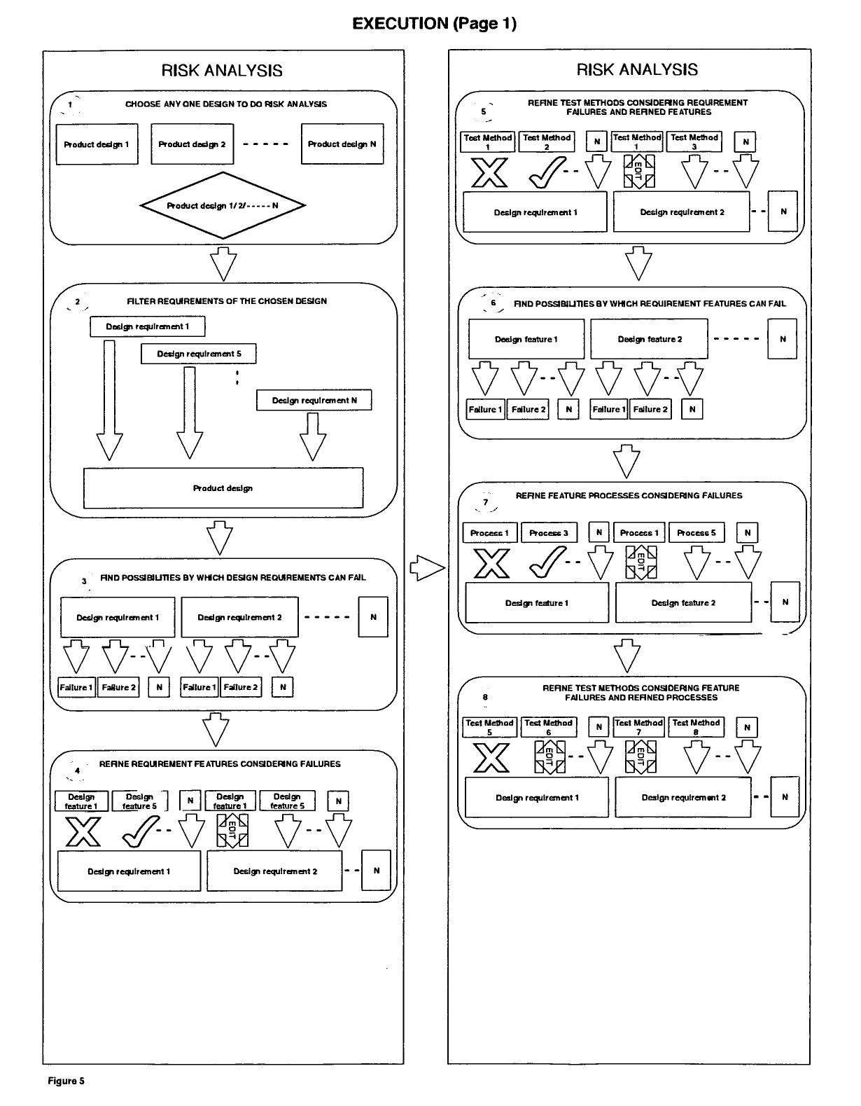

As indicated in FIG. 5, the risk analysis stage filters the requirements of the chosen design and in the next stage applies different possibilities and risk factors for failure of the product. In this manner, the system accumulates different facts, figures and analysis for the failure of the concept and product.

Based on the factors of failure the system redefines the design features of the product. The redesigning is done in order to avoid the factors contributing towards the failure of the product. The process is repeated multiple phases and with different generated possibilities and redefined designs. FIG. 5 gives the complete flow for the process of risk analysis and refining features to avoid failure in real time by application of multiple algorithms.

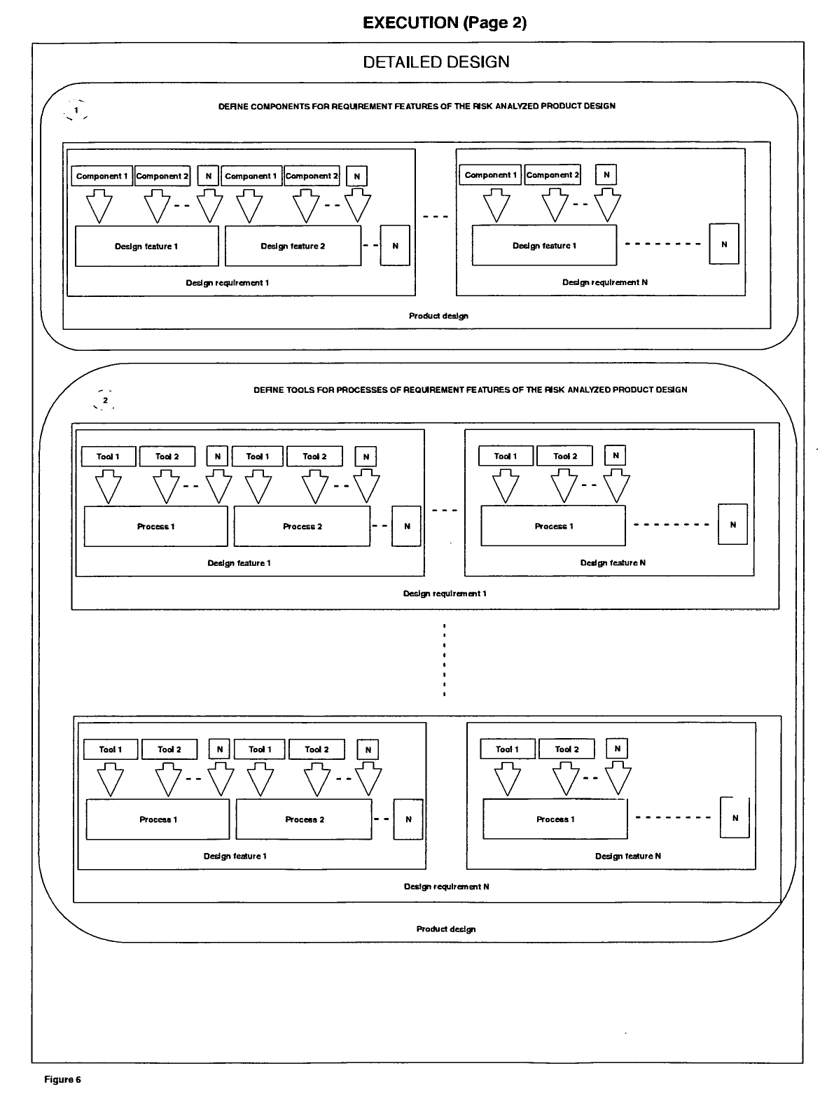

In the next stage the system automatically defines the components and approved features of the product and concept, which are test through the risk assessment cycle. Based on the refined components the system further develops and defines the tools for processes of requirement features, which are now redefined and refined after risk analysis. FIG. 6 gives the flow process and in this very stage completes the refining of the design and gives the prototype design for the concept or product.

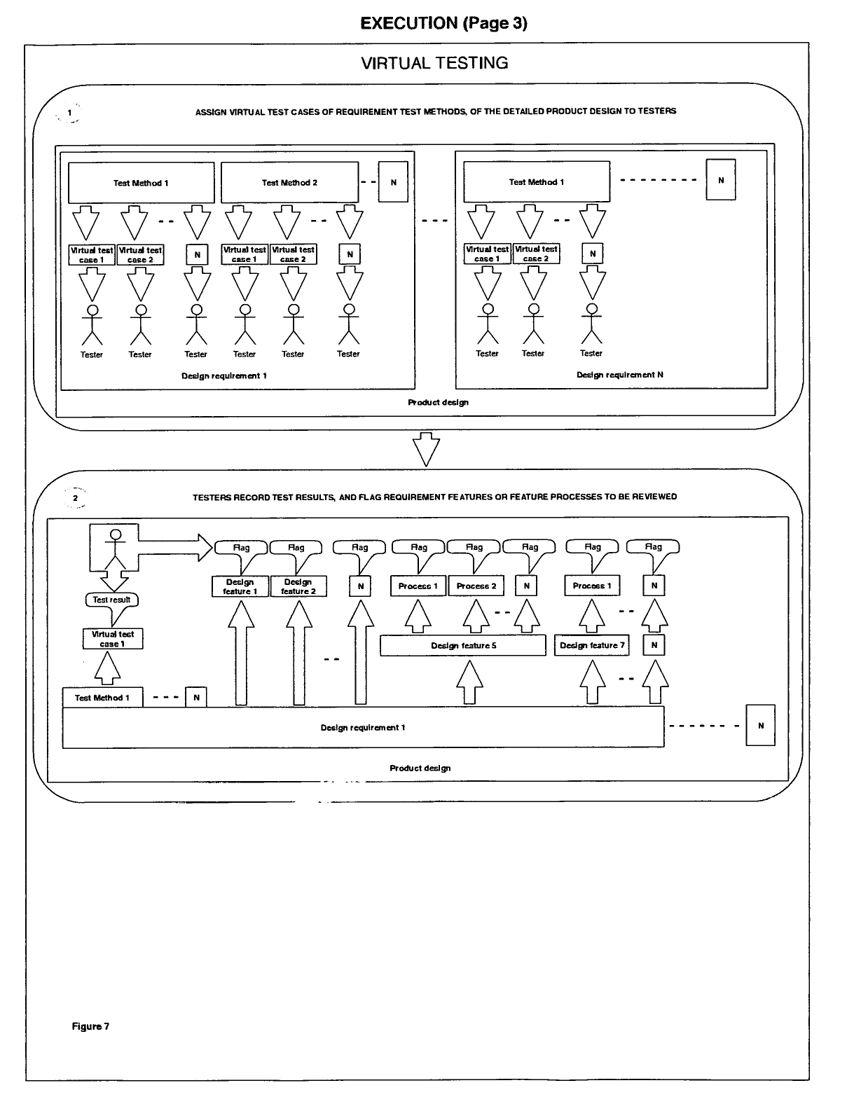

The next stage is based on virtual testing of the product prototype by applying different tests and real time scenarios. These all tests are applied in light of the algorithms and AI tools based on real time business scenarios. FIG. 7 gives the flow process for virtual testing at backhand in the developed application.

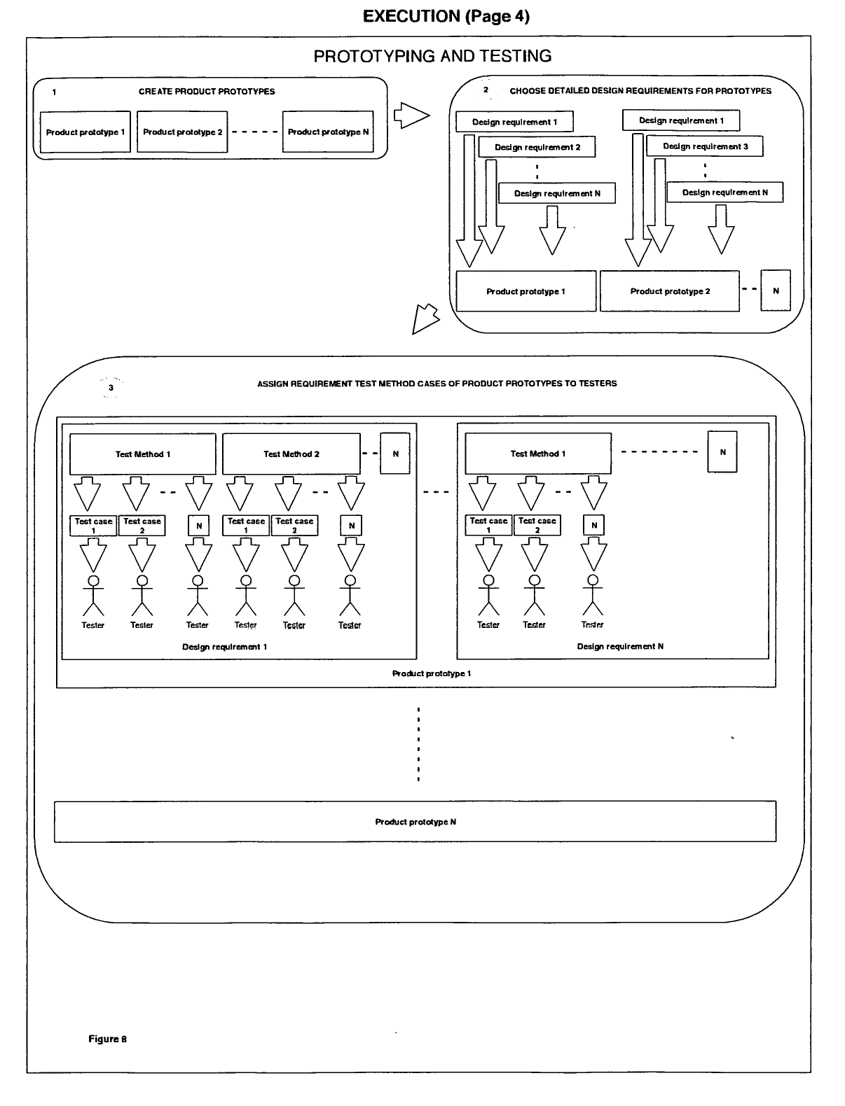

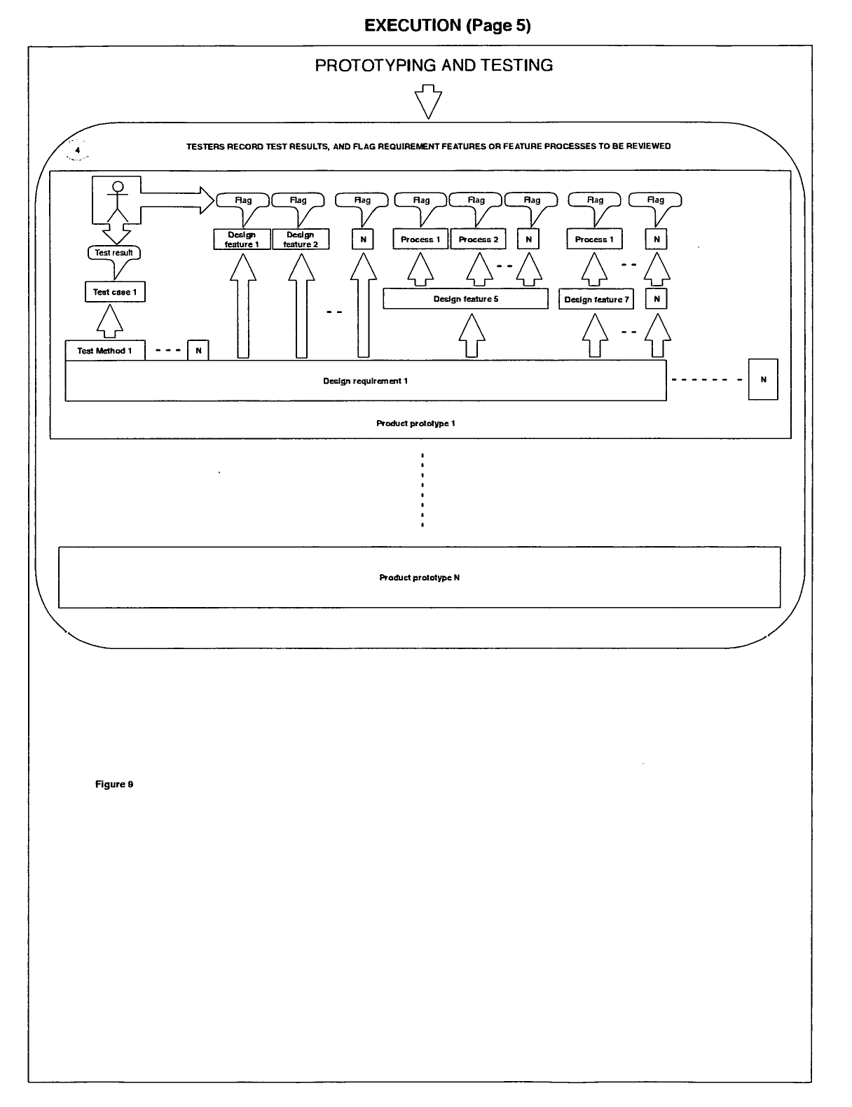

The last stage of execution phase is to give the output as a built product with all stages and analysis. The output is based on the optimum design and solution built on the raw idea or concept. At this very stage, the system also gives the financial aspects of the concept and the estimate costs, time factor and real time analysis for the final product. FIG. 8 indicates the complete flow process of built application for prototyping and testing with application of multiple tests. FIG. 9 indicates the complete testing phase with all gathered inputs inclusive of flags, design features and different test cases.

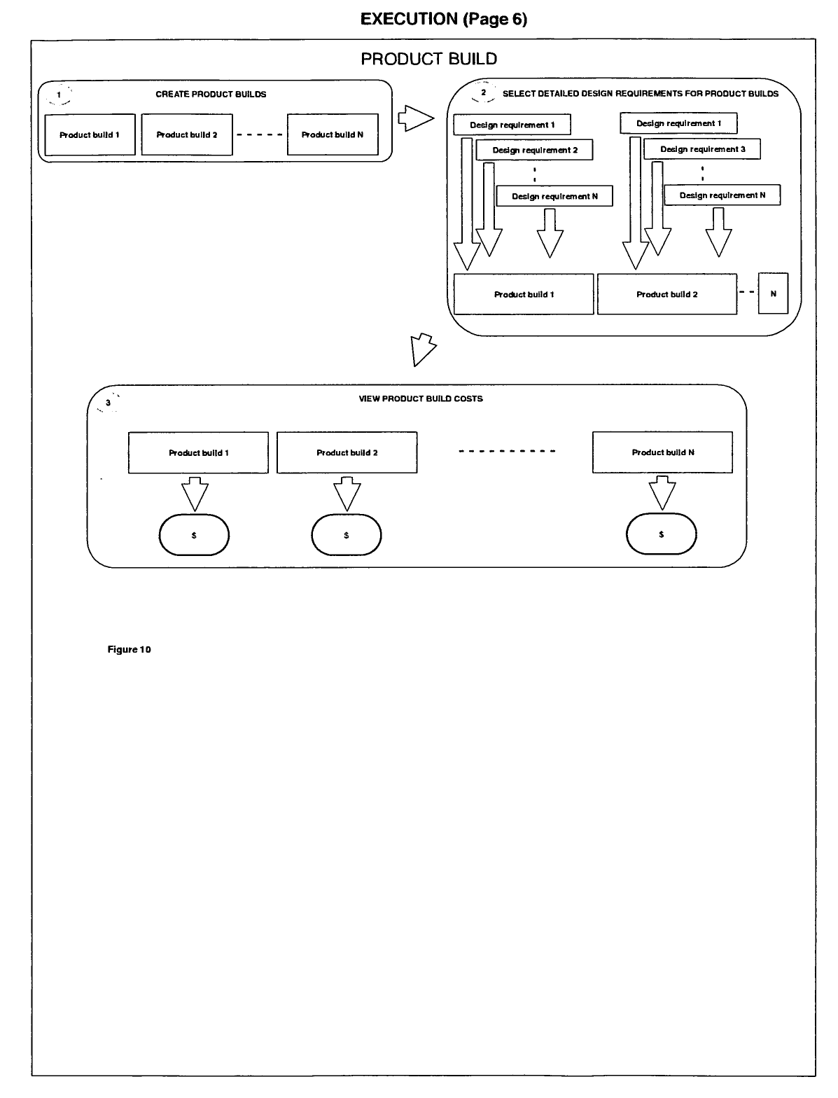

The last stage is based on the feedback provided by the user for the developed product. Based on the feedback some amendments can be further done at different stages of the product development. Once the user accepts the prototype the details and built product with all the processes is given to the customer for execution and taking forward in the market. FIG. 10 gives the flow process for the final execution stage where the product inclusive of costing documentation is built.

In a preferred embodiment of the present invention, the whole system is based on knowledge source modules including a rule-base knowledge source module and/or a case-based knowledge source module. The rule-based knowledge source module has a forward-chaining belief propagation scheme including rules in if-then-else form with associated levels of belief. The case-based knowledge source module has a data comparison scheme including predefincd patterns and conditions, whereupon execution of the case-based knowledge source, the conditions are inferred to be true if a certain level of closeness is found between the received data and the patterns.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

### DESCRIPTION OF DIAGRAMS

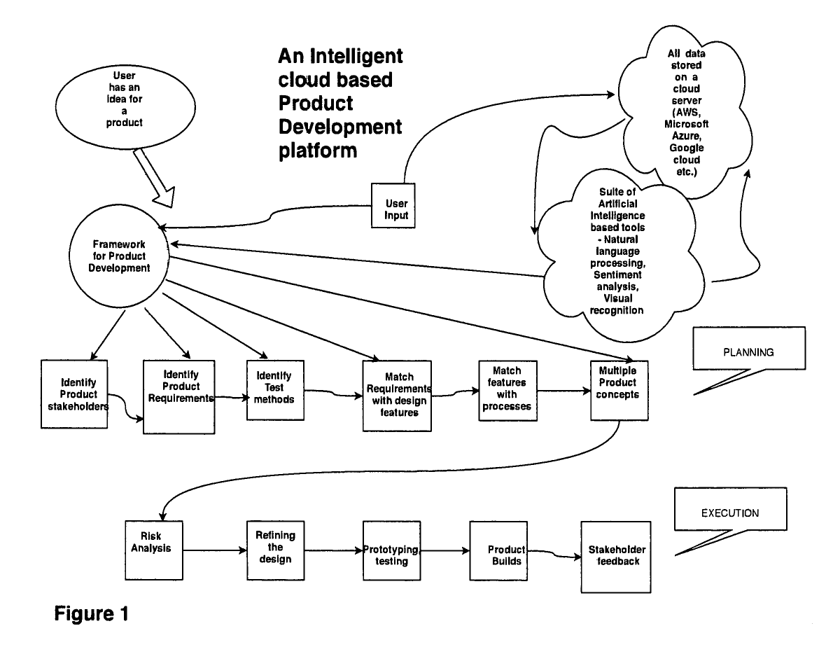

FIG. 1 is the overall process flow for the developed application;

FIG. 2 is the block diagram of the overall process indicating the 3 stages involved in building the product portfolio and design;

FIG. 3 is the first phase of planning of product development;

FIG. 4 is the second phase of planning of product development;

FIG. 5 is the first phase of execution of product development;

FIG. 6 is the second phase of execution of product development;

FIG. 7 is the third phase of execution of product development;

FIG. 8 is the fourth phase of execution of product development;

FIG. 9 is the fifth phase of execution of product development;

FIG. 10 is the sixth phase of execution of product development.

1. A cloud based software application, which delivers a successful product from an idea by using a framework of product development and design thinking and a system of AI algorithms to guide the user. A system for managing a complete product development prototype generated through users input, comprising:
A complete overall application which combines a development framework and AI algorithms based on natural language processing, semantic analysis and visual recognition to provide accurate guidance to the user at each step in the process.
AI algorithm or module which takes user input to create an automated and customized context based search on the interne, social media or user created back end databases.
Extraction of product requirements from raw voice of customer data using a natural language processing and semantic analysis-based software module.
Using AI algorithms and modules to match design and process features and testing methods to identified product requirements.
Visual recognition based AI software module, which provides guidance based on images or sketches input by the user.
AI algorithm or module, which guides and automates a product concept risk analysis by matching design and process features to potential failure modes.
A server connected to a plurality of computing resources through cloud based technology, arranged to allow users to develop business ideas, products and service oriented architectures and prototypes with help of AI Suite.
The system according to previous claims, wherein the server enabled by AI tools will further develop and suggest user based on their input for development of the idea.
The system application comprises a user interface; a biz logic; and data structures, wherein the application zone data comprises the user interface; the biz logic; and a data connector, and wherein the customer zone data comprises the data structures and a data Application Programming Interface (API), wherein the data connector is arranged to communicate with the data API, and wherein the data API is arranged to provide data from the data structures to the data connector such that the application uses the data yet leaves data accessible to the customer independently of the application.
The system facilitates the user through the input data for analysis and a development of information flow.
